(19) United States
(12) Patent Application Publication
(10) Pub. No.: US 2008/0159207 A1
(43) Pub. Date: Jul. 3, 2008

(54) METHOD AND APPARATUS FOR COGNITIVE SPECTRUM ASSIGNMENT FOR MESH NETWORKS

(75) Inventors: Stephen N. Levine, Itasca, IL (US); Lawrence M. Ecklund, Wheaton, IL (US); Stephen L. Kuffner, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/617,011

(22) Filed: Dec. 28, 2006

(51) Int. Cl. H04Q 7/00; H04Q 7/24

(52) U.S. Cl. 370/329; 370/338; 370/401; 370/466

(57) ABSTRACT

A node of a wireless mesh network assigns a radio frequency (RF) channel for operation by sensing an interference level in a number of RF channels, determining which RF channels are available for use and selecting the available RF channel having the best performance. The node then attempts to communicate with neighboring nodes of the wireless mesh network using the selected RF channel. If communication with a sufficient number of nodes is not achieved, the node selects an available RF channel having the next best performance, and attempts to communicate with neighboring nodes using the selected RF channel. The process is repeated until the node can communicate with a sufficient number of nodes. The selected RF channel is then assigned for node operation.

### FIELD OF THE INVENTION

The present invention relates generally to communication networks, and in particular to wireless mesh networks.

### BACKGROUND

A mesh network is a wireless, co-operative, communication infrastructure between a number of individual wireless transceivers. This type of infrastructure can be decentralized (with no central service provider), is relatively inexpensive, and very reliable and resilient, as each network node need only transmit as far as the next node. Nodes act as repeaters to transmit data from nearby nodes to peers that are too far away to reach directly, resulting in a network that can span large distances. Mesh networks are also extremely reliable, as each node is connected to several other nodes. If one node drops out of the network, due to hardware failure or any other reason, its neighbors simply find another route. Extra capacity can be installed by adding more nodes. Mesh networks may involve either fixed or mobile devices. Mesh networks are a type of ad-hoc or self-configuring network.

Unlicensed radio spectrum is commonly used for mesh networks using standard protocols such as IEEE 802.11 set of standards for wireless networks operating at 2.4 GHz. This standard use of unlicensed spectrum has limitations in both spectrum propagation and reuse.

As in packet switching, data hops from one device to another until it reaches a given destination. Dynamic routing capabilities included in each device allow this to happen. To implement such dynamic routing capabilities, each device needs to communicate its routing information in real time to every device it connects with. Each device then determines what to do with the data it receives: either pass it on to the next device or keep it. The routing algorithm used should attempt to always ensure that the data takes the most appropriate (fastest) route to its destination.

The choice of radio technology for wireless mesh networks is very important. In a traditional wireless network, where laptops connect to a single access point, each laptop has to share the fixed bandwidth of the access point. With mesh technology, devices in a mesh network will only connect with other devices that are in a set range. As more devices are added to the network, the available bandwidth increases. However, the number of hops, and hence latency, required to communicate between source and destination nodes may also increase.

To prevent increased hop count from diminishing the advantages of multiple transceivers, one common type of architecture for a mobile mesh network includes multiple fixed base stations with “cut through” high-bandwidth terrestrial links that will provide gateways to services, wired parts of the Internet and other fixed base stations. The “cut through” bandwidth of the base station infrastructure must be substantial for the network to operate effectively. Since this wireless Internet infrastructure has the potential to be much cheaper than the traditional type, many wireless community network groups are already creating wireless mesh networks.

If the density of nodes is too small, the hop distance may be too large for the selected spectrum, and the network will fail. The use of lower frequency spectrum would enable larger mesh network areas (mesh cells with 10-20 mile diameter, for example) to be covered with fewer nodes. However, over a metropolitan area, the optimal spectrum for reuse may change from mesh cell to cell. Current mesh systems use a single frequency allocation which may not be optimum over large metropolitan areas.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a bock diagram of an exemplary mesh network node in accordance with some embodiments of the invention.

FIG. 2 is a flow chart of a method for cognitive spectrum assignment in accordance with some embodiments of the invention.

FIG. 3 is a diagram of an exemplary mesh network in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to spectrum assignment for mesh networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of spectrum assignment for mesh networks described herein. The non-processor circuits may include, but are not limited to, a radio receiver, a radio transmitter, signal drivers, clock circuits, power source circuits, and user input devices. As such, these functions may be interpreted as a method to perform spectrum assignment for mesh networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to methods and apparatus for increasing mesh coverage and spectrum reuse in a wireless mesh network. In one embodiment, this is achieved through the use of cognitive radio methods for acquiring licensed spectrum that is available for reuse in local area “cells” or submesh network. A cognitive radio method is a method for wireless communication in which a wireless node can change particular transmission or reception parameters in order to efficiently utilize a variety of spectrum opportunities without causing harmful interference to higher priority occupants. This parameter alteration is based on observations of several factors from the external and internal cognitive radio environment, such as radio frequency spectrum, user behavior, and network state.

In one embodiment, the node selects between spectrum bands, such as broadcast television (TV) channels, assigned to licensed users. Acquisition of TV spectrum having superior propagation parameters, for example, allows for larger node coverage areas, thereby reducing the number of nodes needed per unit area of coverage. In addition, mesh cells can select unused spectrum for use within their local area or submesh network. The selected spectrum in one submesh may be different than that in other submesh networks.

Adjacent submesh networks may use different TV channels for reduced inter-cell interference or may employ single frequency reuse techniques known in the art.

In one embodiment of the invention, a node of a wireless mesh network having a number of nodes assigns a radio frequency (RF) channel for operation of a submesh network of the wireless network by determining a metric of communication performance of the submesh network in each of a plurality of RF channels and selecting an RF channel of the plurality of RF channels to optimize the metric of communication performance to be the assigned RF channel for node operation. The metric of communication performance may be, for example, an interference level in each of the RF channels, an allowed transmission power in each of the RF channels, a channel propagation characteristic of each of the plurality of RF channels, a location, or a combination thereof.

From the RF channels which satisfy the performance metric, the RF channel having the lowest frequency may be selected.

The node attempts to communicate with neighboring nodes of the wireless mesh network using the selected RF channel and, if communication with a sufficient number of nodes is not achieved, the node selects an RF channel having the next best communication performance (as indicated by the metric of communication performance) and attempts communication with neighboring nodes of the wireless mesh network using the selected RF channel. When communication with a sufficient number of nodes is achieved, the selected RF channel is assigned for node operation.

The node may discover the air-interface protocol of neighboring nodes and declare itself to be a bridge node if a first set of neighboring nodes has a first air-interface protocol and a second set of neighboring nodes has a second air-interface protocol, different from the first air-interface protocol. The bridge node operates under the first air-interface protocol to communicate with nodes in the first set of neighboring nodes and operates under the second air-interface protocol to communicate with nodes in the second set of neighboring nodes. The first and second air-interface protocols may use different RF channels, or different medium access layers, for example.

A node may detect the operation of other nodes of the wireless mesh network on the RF channels and select an RF channel of the available RF channels dependent upon the presence of other nodes on the RF channel.

The node may detect the operation of other nodes of the wireless mesh network on the selected RF channels and selecting an RF channel other than the selected RF channel if a node having higher priority is operating on the selected RF channel.

The metric of performance may include a quality of service (QoS) metric, such as latency performance or bit error rate.

In one embodiment of the invention, a mesh network node has a radio frequency (RF) circuit operable to receive RF spectrum signals, a scanner coupled to the RF circuit and operable to sense interference levels in a plurality of RF channels and identify available RF channels, a selection module, responsive to the sensed interference levels and operable to select an available RF channel to optimize a performance metric, and a data modem coupled to the RF circuit and operable to modulate and demodulate signals in accordance with the selected available RF channel.

The node may also include a processor operable to produce signals to attempt to communicate with neighboring mesh network nodes using the data modem and the RF circuit. The selection module may select an available RF channel having the next best communication performance if the mesh is unable to communicate with a sufficient number of neighboring mesh network nodes. In addition, the processor may discover the assigned RF channels of neighboring mesh network nodes and declare itself to be a bridge node if a first set of neighboring mesh network nodes has a first assigned RF channel and a second set of neighboring mesh network nodes has a second assigned RF channel, different from the first assigned RF channel.

If the mesh network node is bridge node, the data modem may operate in the first assigned RF channel to communicate with mesh network nodes in the first set of neighboring mesh network nodes and operate in the second assigned RF channel to communicate with mesh network nodes in the second set of neighboring mesh network nodes.

The processor may be operated to discover the air-interface protocol used by neighboring mesh network nodes and declare the node to be a bridge node if a first set of neighboring mesh network nodes has a first air-interface protocol and a second set of neighboring mesh network nodes has a second air-interface protocol, different from the first air-interface protocol. In this case, the data modem is operable using the first air-interface protocol to communicate with mesh network nodes in the first set of neighboring mesh network nodes and is operable using the second air-interface protocol to communicate with mesh network nodes in the second set of neighboring mesh network nodes.

In addition, the processor may be operated to discover the assigned RF channels of neighboring mesh network nodes operating on available RF channels, in which case the selection module can select, from the assigned channels, the RF channel having the lowest frequency.

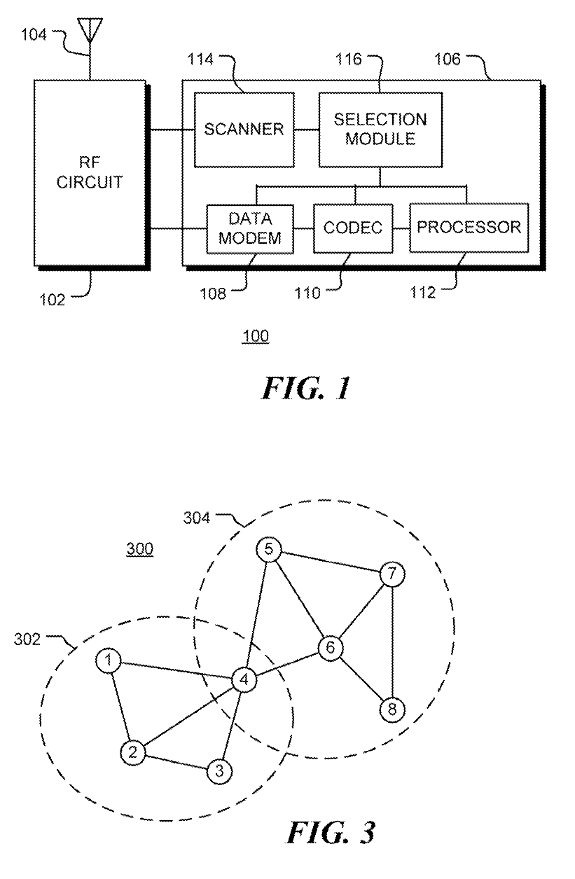

FIG. 1 is a bock diagram of an exemplary mesh network node in accordance with some embodiments of the invention. The node 100 has an analog radio frequency (RF) circuit 102 coupled to a radio antenna 104 that can be used for transmission or reception of radio signals. The RF circuit 102 is coupled to a digital radio module 106. When radio signals are received, the digital radio module 106 demodulates the signals in data modem 108, decodes the demodulated signals in codec 110 and processes the decoded signals in processor 112. When radio signals are to be transmitted, the information is provided by processor 112, encoded in codec 110 and modulated in data modem 108 before being passed to the RF circuit 102 and antenna 104 for transmission.

In one embodiment, the node 100 has a software defined radio, in that the modulation scheme used by the data modem 108 and the encoding and decoding schemes used by the codec 110 are adaptive or reconfigurable under software control. Thus, for example, the modulation may be changed dynamically.

In one embodiment, the node 100 includes a scanner 114 that is coupled to the RF circuit 102 and is operable to measure the radio spectrum sensed by the antenna 104 across one or more frequency bands. This enables the signal strengths and occupants in various spectral channels to be determined. The sensed RF spectrum is passed to a selection module 116 that is operable to select a channel to be used by the node. The selected channel is used by the data modem 108. In addition, the selection module 116 may select parameters that control the operation of the codec 110 and the processor 112. In this embodiment, the node is cognizant of the RF environment in which it is to operate, and is able to adapt its operating characteristics accordingly.

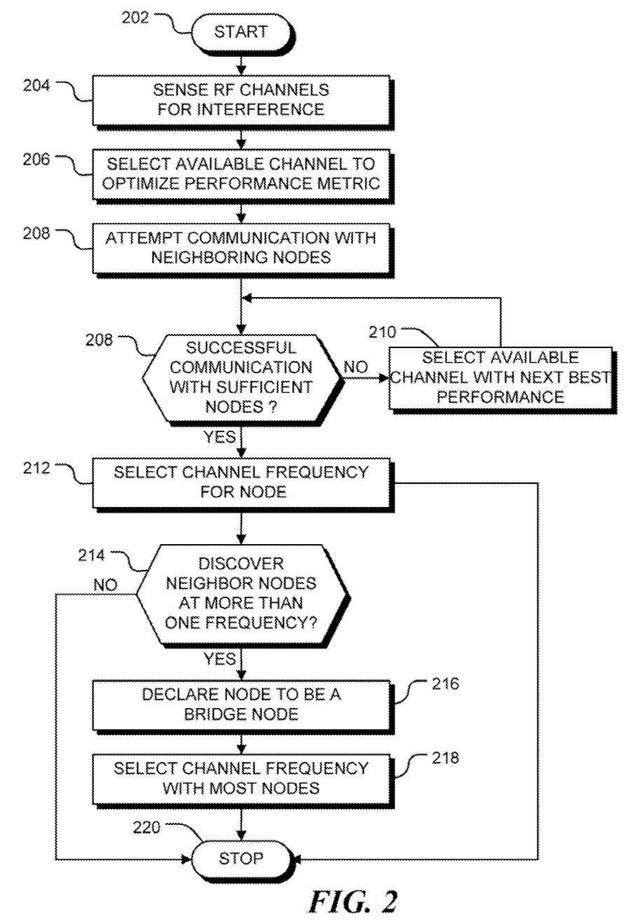

FIG. 2 is a flow chart of a method for cognitive spectrum assignment in accordance with some embodiments of the invention. Referring to FIG. 2, mesh spectrum configuration begins at start block 202. At block 204 an individual mesh node of a mesh cell senses a number of RF channels, such as licensed TV channels. Signals detected on the channels are considered as potential sources of interference. At block 206, each node chooses the frequency channel that is available with acceptable interference. The channels to be scanned may be selected by accessing a database, such as a FCC database, of channel usage. The frequency channel is chosen to optimize some metric or predictor of communication performance, such as Quality of Service (QoS). The QoS metric may be, for example, latency performance or bit error performance. In another example, the available channel having lowest frequency is selected, since low frequency signals tend to have better propagation characteristics. At block 208, a node uses a frequency in the selected channel to attempt to communicate with neighboring nodes. Typically, most of the nodes will have selected the same channel and so are able to exchange information identifying themselves. The identification information includes location information, so a node is able to determine if a node is a neighboring node. If a node is only able to exchange information with a very small number of neighboring cells, as depicted by the negative branch from decision block 208, then the node switches to the available channel with the next best QoS at block 210 and the process is repeated. In this manner, nodes that sense an RF environment different from its neighbors will be able to select successive frequency channels until the dominating channel frequency is found for the submesh network.

Nodes on the edge of two submesh networks will discover that some neighboring nodes have selected one frequency while a comparable number of nodes have selected a different frequency. If a node discovers this situation, as depicted by the positive branch from decision block 214, the node is declared to be a bridge node at block 216. The bridge node selects the frequency channel with the most nodes or, if the number is equal for each channel, chooses between the two at random or in accordance with a prescribed criterion (e.g. lowest frequency). The bridge nodes thereby know that they are on a submesh network edge, and that they are required to switch their frequencies to the appropriate channel when asked to forward information into the adjacent submesh networks. Apart from operating in different RF channels, adjacent submesh networks may operate using different air-interface protocols, such as different media access layers (network, data-link or physical layers). The process terminates at block 220. The process also terminates at block 220, if the node is not a bridge node, as depicted by the negative branch from decision block 214.

A mesh node can monitor other RF channels to see if a new mesh becomes available on a different frequency. If a new node becomes available on a different frequency the original node can decide to operate at its original frequency or switch to the frequency of the new node.

A new mesh node may operate on a different frequency because, for example, it couldn't detect the original node, it detected a transmitter hidden from the original node, or it detected a different submesh and elected to join that submesh. In the last scenario, the new node could contact the original node and become a bridge node.

The cognitive spectrum configuration method described above allows for the dynamic configuration of very large mesh communication systems. Through the use multi-node spectrum sensing for mesh communications, each mesh cell can optimize its selection of channel usage that minimizes interference within their cell area and to the incumbent user. As such, very large metropolitan mesh networks can be configured, which provides optimal spectrum reuse.

Selection of the optimal frequency spectrum allows the number of nodes to be minimized. As necessary, additional nodes can be added to fill in any holes in the mesh cell area.

FIG. 3 is a diagram of an exemplary mesh network in accordance with some embodiments of the invention. Referring to FIG. 3, the mesh network 300 includes nodes 1-8. Nodes 1-4 are configured in a first submesh network 302, while nodes 4-8 are configured in a second submesh network 304. Node 4 is a bridge node. The nodes in each submesh network select their own operating channel. Since the submesh networks may select different operating channels, the bridge node is required to switch its frequency to the appropriate channel when asked to forward information into the adjacent submesh networks. It is able to do this because, as described above, it detects that it is a bridge node during the frequency selection procedure.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for a node of a wireless mesh network having a plurality of nodes to assign a radio frequency (RF) channel for operation of a submesh network of the wireless network, the method comprising:
determining a metric of communication performance of the submesh network in each of a plurality of RF channels; and
selecting an RF channel of the plurality of RF channels to optimize the metric of communication performance to be the assigned RF channel for node operation.

2. A method in accordance with claim 1, wherein the metric of communication performance comprises a metric selected from the group of metrics consisting of
an interference level in each of the plurality of RF channels;
an allowed transmission power in each of the plurality of RF channels;
a channel propagation characteristic of each of the plurality of RF channels; and
location.

3. A method in accordance with claim 1, wherein selecting the RF channel of the plurality of RF channels to optimize the metric of communication performance comprises selecting the RF channel having the lowest frequency.

4. A method in accordance with claim 1, further comprising:
attempting communication with neighboring nodes of the wireless mesh network using the selected RF channel;
while communication with a sufficient number of nodes is not achieved:
selecting an RF channel the next best communication performance as indicated by the metric of communication performance; and
attempting communication with neighboring nodes of the wireless mesh network using the selected RF channel; and
assigning the selected RF channel for node operation.

5. A method in accordance with claim 1, wherein the plurality of RF channels comprise a plurality of licensed television channels.

6. A method in accordance with claim 1, further comprising:
discovering the air-interface protocol of neighboring nodes;
the node declaring itself to be a bridge node if a first set of neighboring nodes has a first air-interface protocol and a second set of neighboring nodes has a second air-interface protocol, different from the first air-interface protocol,
the bridge node operating under the first air-interface protocol to communicate with nodes in the first set of neighboring nodes; and
the bridge node operating under the second air-interface protocol to communicate with nodes in the second set of neighboring nodes.

7. A method in accordance with claim 6, wherein the first and second air-interface protocols use different RF channels.

8. A method in accordance with claim 6, wherein the first and second air-interface protocols use different medium access layers.

9. A method in accordance with claim 1, further comprising:
detecting the operation of other nodes of the wireless mesh network on the plurality of RF channels; and
selecting an RF channel of the available RF channels dependent upon the presence of other nodes on the RF channel.

10. A method in accordance with claim 1, further comprising:
detecting the operation of other nodes of the wireless mesh network on the selected RF channels; and
selecting an RF channel other than the selected RF channel if a node having higher priority is operating on the selected RF channel.

11. A method in accordance with claim 1, wherein the metric of communication performance comprises a quality of service (QoS) metric.

12. A method in accordance with claim 11, wherein the QoS metric comprises a metric selected from the group of metrics consisting of latency performance and bit error rate.

13. A mesh network node comprising:
a radio frequency (RF) circuit operable to receive RF spectrum signals;
a scanner coupled to the RF circuit and operable to sense interference levels in a plurality of RF channels and identify available RF channels;
a selection module, responsive to the sensed interference levels and operable to select an available RF channel to optimize a performance metric;
a data modem coupled to the RF circuit and operable to modulate and demodulate signals in accordance with the selected available RF channel.

14. A mesh network node in accordance with claim 13, further comprising a processor operable to produce signals to attempt to communicate with neighboring mesh network nodes using the data modem and the RF circuit.

15. A mesh network node in accordance with claim 14, wherein the selection module is further operable to select an available RF channel having the next best communication performance if the mesh is unable to communicate with a sufficient number of neighboring mesh network nodes.

16. A mesh network node in accordance with claim 14, wherein the processor is further operable to:
discover the assigned RF channels of neighboring mesh network nodes; and
declare itself to be a bridge node if a first set of neighboring mesh network nodes has a first assigned RF channel and a second set of neighboring mesh network nodes has a second assigned RF channel, different from the first assigned RF channel.

17. A mesh network node in accordance with claim 16, wherein, if the mesh network node is bridge node, the data modem is operable in the first assigned RF channel to communicate with mesh network nodes in the first set of neighboring mesh network nodes and is operable in the second assigned RF channel to communicate with mesh network nodes in the second set of neighboring mesh network nodes.

18. A mesh network node in accordance with claim 14, wherein the processor is further operable to:
discover the air-interface protocol used by neighboring mesh network nodes; and
declare itself to be a bridge node if a first set of neighboring mesh network nodes has a first air-interface protocol and a second set of neighboring mesh network nodes has a second air-interface protocol, different from the first air-interface protocol,
wherein, if the mesh network node is bridge node, the data modem is operable using the first air-interface protocol to communicate with mesh network nodes in the first set of neighboring mesh network nodes and is operable using the second air-interface protocol to communicate with mesh network nodes in the second set of neighboring mesh network nodes.

19. A mesh network node in accordance with claim 18, wherein the processor is further operable to discover the assigned RF channels of neighboring mesh network nodes operating on available RF channels; and wherein the selection module is further operable to select from the assigned channels, an RF channel having the lowest frequency

20. A mesh network comprising a plurality of nodes in accordance with claim 13.
